(19) United States
(12) Patent Application Publication
(10) Pub. No.: US 2026/0127092 A1
(43) Pub. Date: May 7, 2026

(54) GENERATING VIOLATION WAIVERS FOR STATIC LINT CHECK

(71) Applicant: Synopsys, Inc., Sunnyvale, CA (US)

(72) Inventors: Tanu Aneja, Cupertino, CA (US); Mohan Mangal, Fremont, CA (US); Shekaripuram V. Venkatesh, Los Altos, CA (US); Himanshu Kathuria, Fremont, CA (US); Rohit Kumar Ohlayan, New Delhi (IN); Paras Mal Jain, San Jose, CA (US)

(21) Appl. No.: 18/938,186

(22) Filed: Nov. 5, 2024

(51) Int. Cl. G06F 11/36; G06F 8/41

(52) U.S. Cl. CPC G06F 11/3608; G06F 8/41

(57) ABSTRACT

In one example, a method includes converting source code for a register transfer level design into a directed graph, acquiring a first violation generated by analyzing the source code, identifying a violation statement subgraph associated with the first violation in the directed graph, extracting a reduced subgraph representing the first violation from the directed graph, wherein the violation statement subgraph comprises a starting point for the reduced subgraph, converting the reduced subgraph to a first vector, calculating a graph similarity between the first vector and a second vector representing a second violation for the source code for which an existing waiver has been generated, determining, by a processing device, that the graph similarity satisfies a threshold similarity, and generating, in response to the determining, a waiver for the first violation.

### TECHNICAL FIELD

The present disclosure relates generally to register transfer level (RTL) design and relates more particularly to generating violation waivers for static lint check.

### BACKGROUND

Static link check tools are used to detect programming errors, bugs, stylistic errors, and suspicious constructs in source code. Many static lint check tools generate alerts, or violations, when errors or bugs are detected.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 is a flow diagram illustrating one example of a method for automatically generating violation waivers for static lint check.

FIG. 2 illustrates an example minimal subgraph that may be generated during the method illustrated in FIG. 1.

FIG. 3 illustrates a graphical representation of a method for comparing existing waivers that have been generated for the same source code for which a violation is generated.

FIG. 4 illustrates a graphical representation of a method for using a machine learning model that is trained using pre-existing waivers to predict new waivers for source code that is different from pre-existing source code from which the pre-existing waivers were generated.

FIGS. 5A-5D illustrate graphical representations of a system that may be used perform at least some of the steps of the method illustrated FIG. 1.

FIG. 6 depicts a flowchart of various processes used during the design and manufacture of an integrated circuit in accordance with some embodiments of the present disclosure.

FIG. 7 depicts a diagram of an example computer system in which embodiments of the present disclosure may operate.

### DETAILED DESCRIPTION

Aspects of the present disclosure relate to automatically generating violation waivers for static lint check. As discussed above, static link check tools are used to detect programming errors, bugs, stylistic errors, and suspicious constructs in source code. Many static lint check tools generate alerts, or violations, when errors or bugs are detected. These violations are manually reviewed by programmers or register transfer level (RTL) designers.

Many violations generated by static lint check tools end up being either false positives or redundant instances of the same violations. When a false positive or redundant violation is detected, the person reviewing the violations generates a waiver. A waiver indicates that the violation with which the waiver is associated can be ignored. However, having to manually review these false positives and redundant violations can add substantially to the amount of time spent reviewing violations, without providing any new useful information.

Examples of the present disclosure use machine learning techniques to review static lint check violations and automatically generate waivers when violations are predicted to be either false positives or redundant violations. In one example, an instance of source code is converted into a graph from which a reduced (e.g., minimal) subgraph representing a violation can be extracted. The reduced subgraph can then be compared to reduced subgraphs of violations that were waived for the same source code, for a historical instance of source code, or for both, and a similarity metric computed. If the similarity metric at least meets a threshold similarity metric, then a waiver may be generated for the violation corresponding to the extracted reduced subgraph. In another example, machine learning techniques could be used to compare the reduced subgraph to reduced subgraphs of waivers that were generated for historical (other) instances of source code. The machine learning techniques may predict whether the violation represented by the reduced subgraph should be waived based on the comparison.

Technical advantages of the present disclosure include, but are not limited to, the ability to reduce the amount of time spent reviewing static lint check violations for waivers from days or weeks to a matter of hours, without loss of accuracy. Furthermore, examples of the present disclosure improve the functioning of a computer or electronic design/system by accurately distinguishing genuine lint violations in source code from false positives or redundancies, thereby resulting in better functioning source code that contains fewer bugs and errors.

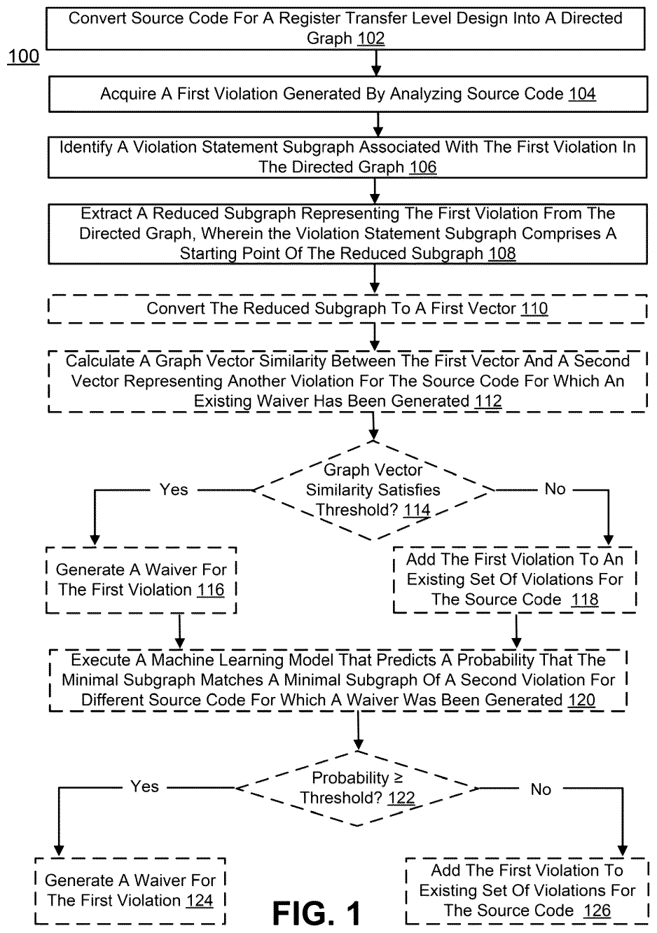

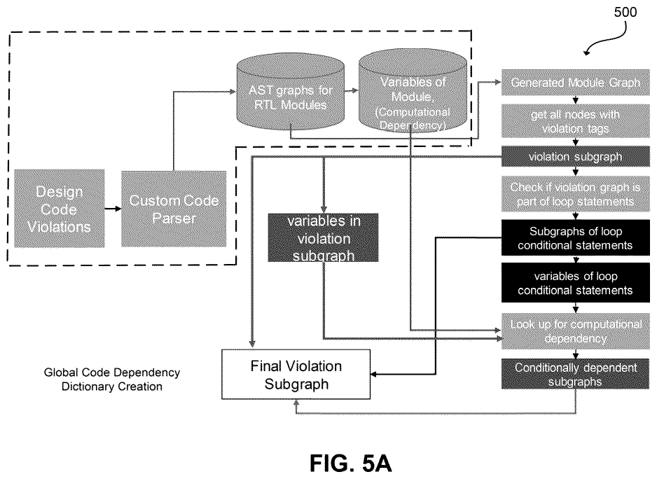

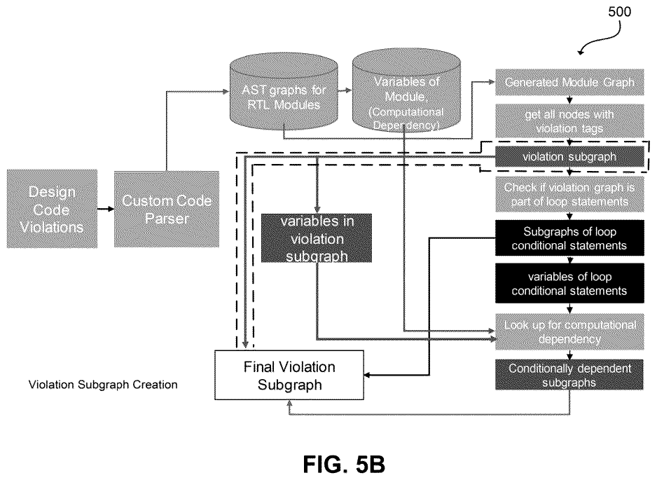

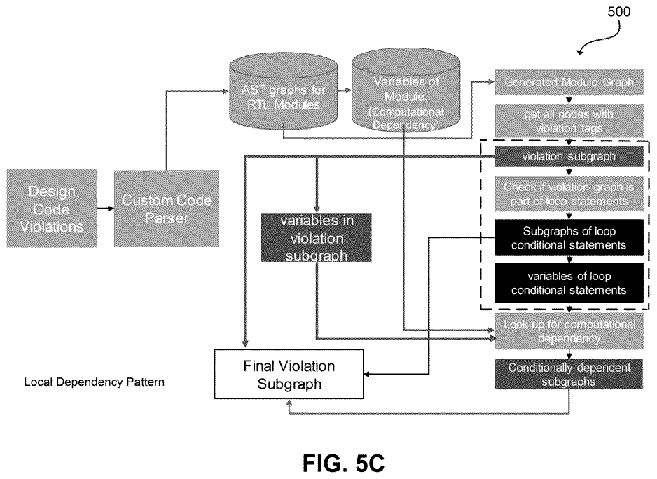

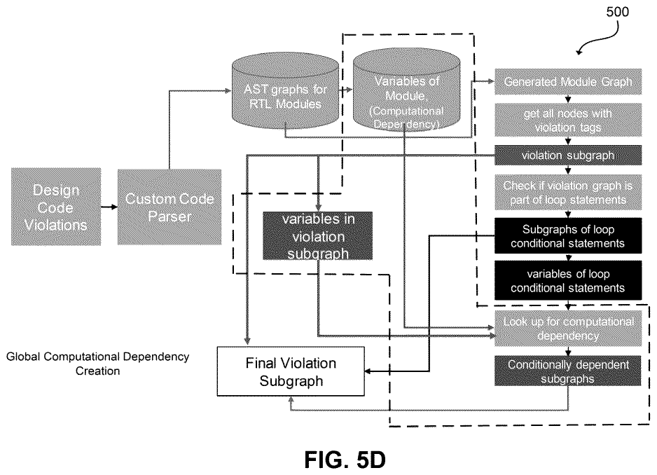

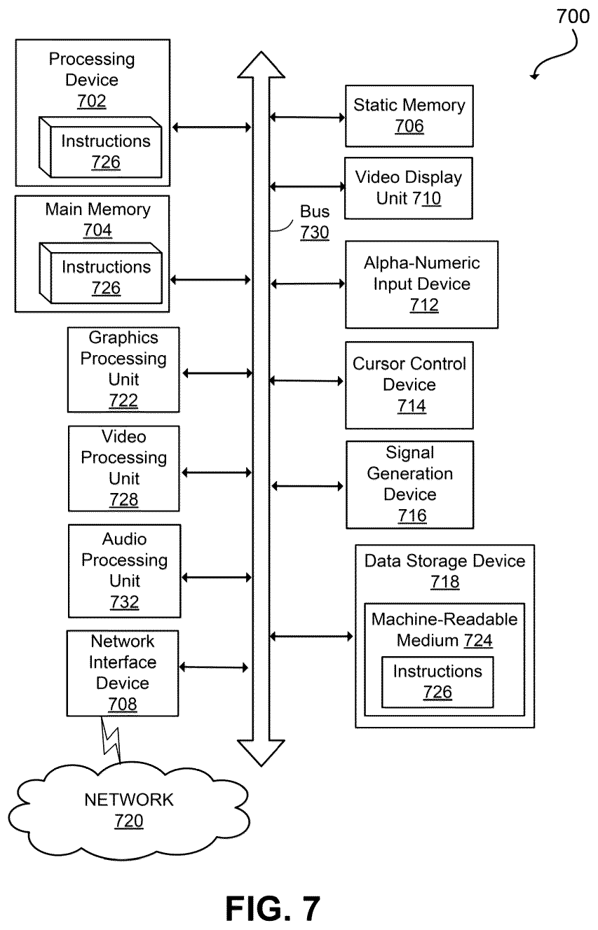

FIG. 1 is a flow diagram illustrating one example of a method 100 for automatically generating violation waivers for static lint check. In one example, the method 100 may be performed by a processing device, such as the processing device 702 of FIG. 7. However, in other examples, the method 100 may be performed by another computing device or system. FIGS. 5A-5D, for instance, illustrate graphical representations of a system 500 that may be used perform at least some of the steps of the method 100 illustrated FIG. 1. For the sake of example, the method 100 is described below as being performed by a processing system.

In step 102, the processing system may convert source code for a register transfer level design into a directed graph.

In one example, an abstract syntax tree (AST) parser may be used to perform top-to-bottom RTL code de-compilation that converts RTL code to a directed graph (e.g., an AST graph). In one example, the directed graph may comprise a plurality of nodes connected by a plurality of edges, where each node of the plurality of nodes has the following attributes: operator category and operator value (e.g., an “if” variable). In a further example, a computational dependency may be searched in the directed graph for each variable (leaf node), and a global dictionary may be created from the computational dependencies. If a variable has more than one parent node, then the variable is part of multiple RTL statements, and, hence, is computationally dependent on multiple variables.

FIG. 5A, for instance, illustrates an example system 500 that may be used to perform step 102 as well as other steps of the method 100. In FIG. 5A, dashed lines enclose the components of the system 500 which may be used to generate the AST graph of each RTL module, search computational dependencies for variables of the AST graph, and generate a global code dependency dictionary.

In step 104, the processing system may acquire a first violation generated by analyzing source code.

In one example, the violation may be generated by a static lint check tool which has analyzed the source code. The static lint check tool may be any available static lint check tool. In one example, the static lint check tool may generate a plurality of violations for the source code, and the method 100 may be performed for each violation of the plurality of violations. Thus, the first violation may be one violation of the plurality of violations. However, the use of the term “first” is used only to help differentiate from other violations of the plurality of violations and is not intended to imply any sort of order in which the plurality of violations is processed. That is, the first violation may not necessarily be the first violation of the plurality of violations to be processed.

In step 106, the processing system may identify a violation statement subgraph associated with the first violation in the directed graph.

That is, the processing system may identify a subgraph within the directed graph of the source code (that was generated in step 102), where the subgraph represents the portion of the source code that corresponds to the first violation generated by the static lint check tool.

To facilitate step 106, it should be noted that the directed graph of the source code includes a plurality of nodes having the following attributes: operator category and operator value. In one example, the AST parser may also tag nodes of the directed graph with an additional attribute to mark the starting point of a violation statement subgraph (e.g., as identified in step 106 of FIG. 1).

In step 108, the processing system may extract a reduced subgraph representing the first violation from the directed graph, wherein the violation statement subgraph comprises a starting point of the reduced subgraph for the first violation.

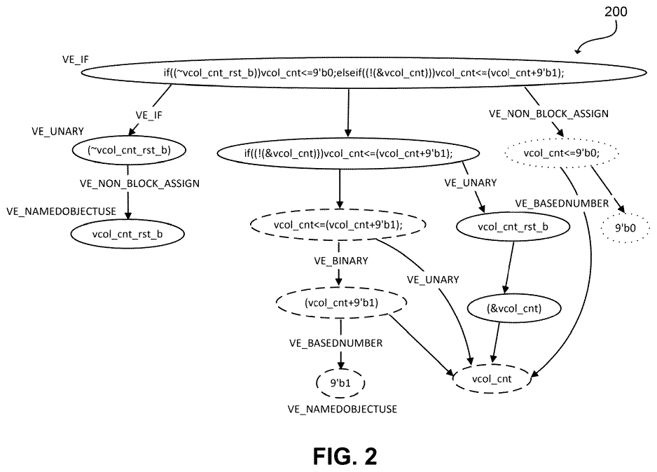

In one example, the reduced subgraph may be a minimal subgraph. FIG. 2, for instance, illustrates a minimal subgraph 200 that may be generated in step 108. In FIG. 2, the violation statement subgraph of the example directed graph 200 is indicated by the nodes that are outlined in dashed lines. FIG. 5B illustrates, within dashed lines, components of the system 500 which may be used to tag nodes with attributes to mark the starting point of the violation statement subgraph (e.g., as discussed in connection with step 106).

In one example, once the violation statement subgraph is identified, the AST parser may traverse backward through the directed graph from the nodes that mark the starting point of the violation statement subgraph to the root node of the directed graph to determine whether the violation statement is part of a block statement (e.g., if-else, for, etc.). FIG. 5C illustrates within dashed lines components of the system 500 which may be used to traverse backward through the directed graph to determine whether the violation statement subgraph is part of a block statement. If the violation statement is determined to be part of a block statement, then the AST parser may create a subgraph for the block statement and add the subgraph of the block statement to the violation statement subgraph to produce an augmented violation statement subgraph. In FIG. 2, the nodes outlined in solid lines represent the subgraph of a block statement (if loop) that has been added to the violation statement subgraph. Thus, the augmented violation statement subgraph of FIG. 2 would include all nodes outlined in solid or dashed lines and all edges connecting those nodes.

In one example, once any block statement subgraphs have been added to the violation statement subgraph, any variables (e.g., leaf nodes) of the resultant augmented violation statement subgraph may be identified, and computational dependencies of these variables on other variables of the directed graph may be determined (e.g., from the global dictionary discussed above). A variable subgraph of the code statement of the variables that are computationally dependent on other variables may be identified and added to the augmented violation statement subgraph to produce the minimal subgraph. In FIG. 2, the variable subgraph is indicated by the nodes outlined in dotted lines; the minimal subgraph thus includes all nodes outlined in solid, dashed, or dotted lines and all edges connecting those nodes. FIG. 5D illustrates within dashed lines components of the system 500 that may be used to find the computational dependencies of the variables and add to the augmented violation statement graph.

Augmentation of the violation statement subgraph with the block statement subgraph(s) and/or variable subgraph(s) provides local and global dependency context for the violation. This illustrates the extraction of the reduced subgraph for a violation as described in step 108 of FIG. 1. Broadly, extraction of the reduced subgraph is achieved by expanding around the subgraph for the violation to a limited extent (e.g., to the minimal extent necessary, in the case of a minimal subgraph) to capture the context of the violation in the directed graph for the source code of the entire RTL design.

In optional step 110 (illustrated in phantom), the processing system may convert the reduced subgraph to a first vector.

In one example, the first vector may comprise an embedding vector that is generated using any conversion architecture that is capable of taking as an input a reduced subgraph for a violation and generating as an output an embedding vector for the unique representation of the reduced subgraph. In one example, graph node attributes that are embedded in first vector may include at least one of: operator category (e.g., IF, FOR, ASSIGN, UNARY, etc.) or operand category (e.g., INT, UINT, CONSTANT, FLOAT, etc.).

In optional step 112 (illustrated in phantom), the processing system may calculate a graph vector similarity between the first vector and a second vector representing a second violation for the source code for which an existing waiver has been generated.

In one example, the second vector may be generated from the second violation in the same way that the first vector is generated from the first violation. The second vector may be one of a plurality of vectors generated in this manner, where each vector of the plurality of vectors corresponds to one waiver or one violation that has already been identified for the source code. In one example, further iterations of the method 100 (or of steps of the method 100) may be performed to compare the first vector to each vector of the plurality of vectors. In one example, the graph vector similarity may be a cosine similarity.

In optional step 114 (illustrated in phantom), the processing system may determine whether the graph vector similarity satisfies a threshold similarity.

In one example, the graph vector similarity satisfies the threshold similarity if the graph vector similarity is greater than or equal to the threshold similarity. In one example, the threshold similarity is configurable (e.g., by a human operator). Thus, the threshold similarity may be tuned to accommodate a desired level of accuracy, time restrictions, or other considerations. In general, however, a higher the threshold similarity will typically result in fewer waivers being automatically generated (and, most likely, a lower probability of genuine violations being erroneously waived). A lower threshold similarity will typically result in more waivers being automatically generated (and, most likely, a higher probability of genuine violations being erroneously waived).

If the processing system concludes in step 114 that the graph vector similarity is satisfies (e.g., is greater than or equal to) the threshold similarity, then the method 100 may proceed to step 116. In optional step 116 (illustrated in phantom), the processing system may generate a waiver for the first violation.

Thus, if the first violation is determined to be similar enough to a previously reviewed violation for which a waiver was generated, then a waiver is also generated for the first violation. The waiver that is generated for the first violation may then be added to an existing set of waivers for the source code and used for the purposes of comparison to other violations that have not yet been reviewed for waivers.

If, on the other hand, the processing system concludes in step 114 that the graph vector similarity does not satisfy (e.g., is less than) the threshold similarity, then the method 100 may proceed to step 118. In optional step 118 (illustrated in phantom), the processing system may add the first violation to an existing set of violations for the source code.

Thus, if the first violation is determined not to be similar enough to a previously reviewed violation for which a waiver was generated, then the first violation may be considered to be a genuine violation (e.g., not a false positive or a redundancy). The first violation may then be added to an existing set of violations for the source.

In some examples, if the processing system concludes in step 114 that the graph similarity is less than the threshold similarity, the method 100 may bypass step 118 and proceed to step 120. Alternatively, the method 100 may proceed to step 120 after performing step 118 as a means of verifying the results of steps 104-118.

In optional step 120 (illustrated in phantom), the processing system may execute a machine learning model that predicts a probability that the reduced subgraph matches a reduced subgraph of a second violation for different source code for which a waiver has been generated.

In one example, the machine learning model comprises a graph convolutional network (GCN) that has been trained using a labeled set of reduced subgraphs of violations and waivers from one or more historical instances of source code (i.e., not including the source code whose violations are currently being reviewed). The GCN may be trained as a binary classification model that takes as an input a reduced subgraph for a violation and generates as an output a classification that indicates whether the input subgraph indicates a waiver or a genuine violation. For instance, the output may be a single bit vector (e.g., 0 or 1, where 0 indicates a waiver and 1 indicates a genuine violation). In one example, the GCN may comprise two GCN layers, a MAX POOL layer, a hidden fully connected (FC) layer, and an output layer.

In optional step 122 (illustrated in phantom), the processing system may determine whether the probability is greater than or equal to a threshold probability.

In one example, the threshold probability is configurable (e.g., by a human operator). Thus, the threshold probability may be tuned to accommodate a desired level of accuracy, time restrictions, or other considerations. For instance, a 50% (or 0.5) threshold probability would result in any violation that is more likely than not to be a waiver to be waived. In general, however, a higher the threshold probability will typically result in fewer waivers being automatically generated (and, most likely, a lower probability of genuine violations being erroneously waived). A lower threshold probability will typically result in more waivers being automatically generated (and, most likely, a higher probability of genuine violations being erroneously waived).

If the processing system concludes in step 122 that the probability is greater than or equal to a threshold probability, then the method 100 may proceed to step 124. In optional step 124, the processing system may generate a waiver for the first violation.

Thus, if the machine learning model classifies the first violation as a waiver, then a waiver is generated for the first violation. The waiver that is generated for the first violation may then be added to an existing set of waivers for the source code and used for the purposes of comparison to other violations that have not yet been reviewed for waivers.

If, on the other hand, the processing system concludes in step 122 that the probability is less than the threshold probability, then the method 100 may proceed to step 126. In optional step 126, the processing system may add the first violation to an existing set of violations for the source code.

Thus, if the machine learning model classifies the first violation as a genuine violation, then the first violation may be considered to be a genuine violation (e.g., not a false positive or a redundancy). The first violation may then be added to an existing set of violations for the source.

As discussed above, steps 102-126 may be performed for each violation that is generated for the source code. Thus, the method 100 may be performed to automatically determines, for each violation, whether the violation should be considered a genuine violation or should be waived.

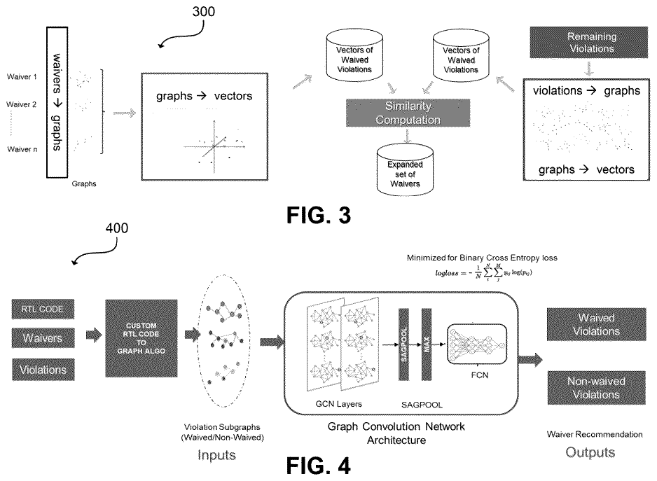

Collectively, steps 110-118 represent one method by which waivers may be automatically generated from static lint check violations using reduced subgraphs of the violations, while steps 120-126 represent a second method by which waivers may be automatically generated from static lint check violations using reduced subgraphs of the violation. More specifically, the first method relies on a comparison to existing waivers that have been generated for the same source code for which the violation was generated, while the second method relies on a comparison of waivers that have been generated for source code that is different from the source code for which the violation was generated. FIG. 3, for instance, illustrates a graphical representation 300 of a method for comparing existing waivers that have been generated for the same source code for which a violation is generated (e.g., in accordance with steps 102-118 of FIG. 1). FIG. 4 illustrates a graphical representation 400 of a method for using a machine learning model that is trained using pre-existing waivers to predict new waivers for source code that is different from pre-existing source code from which the pre-existing waivers were generated (e.g., in accordance with steps 120-126 of FIG. 1).

The first and second method may be used in combination for greater thoroughness; however, either of the first and second method could also be used on its own and still significantly reduce the amount of time required to review violations for waivers. Thus, although steps 110-126 are described above as being optional, it will be appreciated that at least one of steps 110-118 and steps 120-126 will always be carried out when the method 100 is performed.

In some examples, waivers that are automatically generated using the machine learning model in steps 120-126 may be reviewed by a human operator for accuracy. This may result in the human operator discovering a new pattern of waivers. Reduced subgraphs of waivers that are representative of the new patterns of waivers may be used in future iterations of the method 100, specifically in steps 112-118. These future iterations may be iterations that are performed for yet to be examined violations of the same source code, or for violations that are generated in the future for different source code.

Thus, in one example a method according to the present disclosure includes converting source code for a register transfer level design into a directed graph, acquiring a first violation generated by analyzing the source code, identifying a violation statement subgraph associated with the first violation in the directed graph, extracting a reduced subgraph representing the first violation from the directed graph, wherein the violation statement subgraph comprises a starting point for the reduced subgraph, converting the reduced subgraph to a first vector, calculating a graph similarity between the first vector and a second vector representing a second violation for the source code for which an existing waiver has been generated, determining, by a processing device, that the graph similarity satisfies a threshold similarity, and generating, in response to the determining, a waiver for the first violation.

In another example according to the present disclosure, a method includes converting source code for a register transfer level design into a directed graph, acquiring a first violation generated by a static lint check tool analyzing the source code, identifying a violation statement subgraph associated with the first violation in the directed graph, extracting a minimal subgraph representing the first violation from the directed graph, wherein the violation statement subgraph comprises a starting point for the minimal subgraph, executing a machine learning model that predicts a probability that the minimal subgraph matches a minimal subgraph of a second violation for different source code for which a waiver has been generated, determining, by a processing device, that the probability is at least equal to a threshold probability, and generating, in response to the determining, a waiver for the first violation.

In another example, a non-transitory computer readable medium according to the present disclosure stores instructions which, when executed by a processor, cause the processor to convert source code for a register transfer level design into a directed graph, acquire a first violation generated by a static lint check tool analyzing the source code, identify a violation statement subgraph associated with the first violation in the directed graph, extract a minimal subgraph representing the first violation from the directed graph, convert the minimal subgraph to a first vector, wherein the violation statement subgraph comprises a starting point for the minimal subgraph, calculate a graph similarity between the first vector and a second vector representing a second violation for the source code for which an existing waiver has been generated, determine that the graph similarity is less than a threshold similarity, execute, in response to the graph similarity being less than the threshold similarity, a machine learning model that predicts a probability that the minimal subgraph matches a minimal subgraph of a second violation for different source code for which a waiver has been generated, determine that the probability is at least equal to a threshold probability, and generate, in response to the determining, a waiver for the first violation.

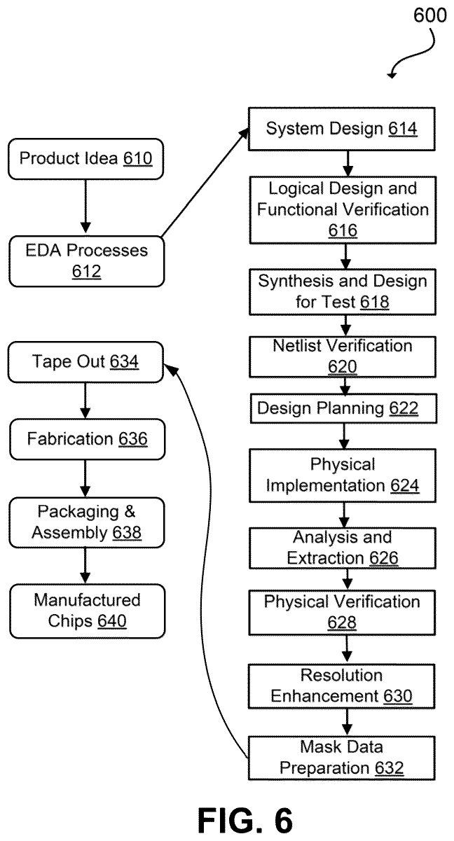

FIG. 6 illustrates an example set of processes 600 used during the design, verification, and fabrication of an article of manufacture such as an integrated circuit to transform and verify design data and instructions that represent the integrated circuit. Each of these processes can be structured and enabled as multiple modules or operations. The term ‘EDA’ signifies the term ‘Electronic Design Automation.’ These processes start with the creation of a product idea 310 with information supplied by a designer, information which is transformed to create an article of manufacture that uses a set of EDA processes 612. When the design is finalized, the design is taped-out 634, which is when artwork (e.g., geometric patterns) for the integrated circuit is sent to a fabrication facility to manufacture the mask set, which is then used to manufacture the integrated circuit. After tape-out, a semiconductor die is fabricated 636 and packaging and assembly processes 638 are performed to produce the finished integrated circuit 640.

Specifications for a circuit or electronic structure may range from low-level transistor material layouts to high-level description languages. A high-level of representation may be used to design circuits and systems, using a hardware description language (‘HDL’) such as VHDL, Verilog, SystemVerilog, SystemC, MyHDL or Open Vera. The HDL description can be transformed to a logic-level register transfer level (‘RTL’) description, a gate-level description, a layout-level description, or a mask-level description. Each lower representation level that is a more detailed description adds more useful detail into the design description, for example, more details for the modules that include the description. The lower levels of representation that are more detailed descriptions can be generated by a computer, derived from a design library, or created by another design automation process. An example of a specification language at a lower level of representation language for specifying more detailed descriptions is SPICE, which is used for detailed descriptions of circuits with many analog components. Descriptions at each level of representation are enabled for use by the corresponding systems of that layer (e.g., a formal verification system). A design process may use a sequence depicted in FIG. 6. The processes described by be enabled by EDA products (or EDA systems).

During system design 614, functionality of an integrated circuit to be manufactured is specified. The design may be optimized for desired characteristics such as power consumption, performance, area (physical and/or lines of code), and reduction of costs, etc. Partitioning of the design into different types of modules or components can occur at this stage.

During logic design and functional verification 616, modules or components in the circuit are specified in one or more description languages and the specification is checked for functional accuracy. For example, the components of the circuit may be verified to generate outputs that match the requirements of the specification of the circuit or system being designed. Functional verification may use simulators and other programs such as testbench generators, static HDL checkers, and formal verifiers. In some embodiments, special systems of components referred to as ‘emulators’ or ‘prototyping systems’ are used to speed up the functional verification.

During synthesis and design for test 618, HDL code is transformed to a netlist. In some embodiments, a netlist may be a graph structure where edges of the graph structure represent components of a circuit and where the nodes of the graph structure represent how the components are interconnected. Both the HDL code and the netlist are hierarchical articles of manufacture that can be used by an EDA product to verify that the integrated circuit, when manufactured, performs according to the specified design. The netlist can be optimized for a target semiconductor manufacturing technology. Additionally, the finished integrated circuit may be tested to verify that the integrated circuit satisfies the requirements of the specification.

During netlist verification 620, the netlist is checked for compliance with timing constraints and for correspondence with the HDL code. During design planning 622, an overall floor plan for the integrated circuit is constructed and analyzed for timing and top-level routing.

During layout or physical implementation 624, physical placement (positioning of circuit components such as transistors or capacitors) and routing (connection of the circuit components by multiple conductors) occurs, and the selection of cells from a library to enable specific logic functions can be performed. As used herein, the term ‘cell’ may specify a set of transistors, other components, and interconnections that provides a Boolean logic function (e.g., AND, OR, NOT, XOR) or a storage function (such as a flipflop or latch). As used herein, a circuit ‘block’ may refer to two or more cells. Both a cell and a circuit block can be referred to as a module or component and are enabled as both physical structures and in simulations. Parameters are specified for selected cells (based on ‘standard cells’) such as size and made accessible in a database for use by EDA products.

During analysis and extraction 626, the circuit function is verified at the layout level, which permits refinement of the layout design. During physical verification 628, the layout design is checked to ensure that manufacturing constraints are correct, such as DRC constraints, electrical constraints, lithographic constraints, and that circuitry function matches the HDL design specification. During resolution enhancement 630, the geometry of the layout is transformed to improve how the circuit design is manufactured.

During tape-out, data is created to be used (after lithographic enhancements are applied if appropriate) for production of lithography masks. During mask data preparation 632, the ‘tape-out’ data is used to produce lithography masks that are used to produce finished integrated circuits.

A storage subsystem of a computer system (such as computer system 700 of FIG. 7) may be used to store the programs and data structures that are used by some or all of the EDA products described herein, and products used for development of cells for the library and for physical and logical design that use the library.

FIG. 7 illustrates an example machine of a computer system 700 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random access memory (DRAM) such as synchronous DRAM (SDRAM), a static memory 706 (e.g., flash memory, static random access memory (SRAM), etc.), and a data storage device 718, which communicate with each other via a bus 730.

Processing device 702 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. The processing device 702 may be configured to execute instructions 726 for performing the operations and steps described herein.

The computer system 700 may further include a network interface device 708 to communicate over the network 720. The computer system 700 also may include a video display unit 710 (e.g., a liquid crystal display (LCD) or a cathode ray tube (CRT)), an alphanumeric input device 712 (e.g., a keyboard), a cursor control device 714 (e.g., a mouse), a graphics processing unit 722, a signal generation device 716 (e.g., a speaker), graphics processing unit 722, video processing unit 728, and audio processing unit 732.

The data storage device 718 may include a machine-readable storage medium 724 (also known as a non-transitory computer-readable medium) on which is stored one or more sets of instructions 726 or software embodying any one or more of the methodologies or functions described herein. The instructions 726 may also reside, completely or at least partially, within the main memory 704 and/or within the processing device 702 during execution thereof by the computer system 700, the main memory 704 and the processing device 702 also constituting machine-readable storage media.

In some implementations, the instructions 726 include instructions to implement functionality corresponding to the present disclosure. While the machine-readable storage medium 724 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 702 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A method, comprising:
converting source code for a register transfer level design into a directed graph;
acquiring a first violation generated by analyzing the source code;
identifying a violation statement subgraph associated with the first violation in the directed graph;
extracting a reduced subgraph representing the first violation from the directed graph, wherein the violation statement subgraph comprises a starting point for the reduced subgraph;
converting the reduced subgraph to a first vector;
calculating a graph similarity between the first vector and a second vector representing a second violation for the source code for which an existing waiver has been generated;
determining, by a processing device, that the graph similarity satisfies a threshold similarity; and
generating, in response to the determining, a waiver for the first violation.

2. The method of claim 1, wherein the converting comprises using an abstract syntax tree parser to perform top-to-bottom register transfer level code de-compilation that converts the source code for the register transfer level design into the directed graph.

3. The method of claim 1, wherein the extracting the reduced subgraph comprises:
extracting from the directed graph a violation statement subgraph from the directed graph based on tags in the directed graph that mark a starting point of the violation statement subgraph, wherein the violation statement subgraph comprises the starting point and a portion of the directed graph beneath the starting point;
augmenting the violation statement subgraph with a subgraph of a block statement of which a violation statement associated with the violation is a part to produce an augmented violation statement subgraph;
augmenting the augmented violation statement subgraph with a variable subgraph of a code statement of any variables of the directed graph that are computationally dependent on variables of the augmented violation statement subgraph.

4. The method of claim 1, wherein the first vector comprises an embedding vector that embeds attributes of nodes of the reduced subgraph.

5. The method of claim 1, wherein the graph similarity is a cosine similarity.

6. The method of claim 1, wherein the second vector is one of a plurality of vectors, wherein each vector of the plurality of vectors corresponds to one waiver or one violation that has already been identified for the source code.

7. The method of claim 6, further comprising:
calculating a plurality of graph similarities between a third vector converted from a reduced subgraph representing a third violation generated by analyzing the source code and each vector of the plurality of vectors;
determining that all graph similarities of the plurality of graph similarities are below the threshold similarity; and
adding, in response to the determining that all graph similarities of the plurality of graph similarities are below the threshold similarity, the third violation to an existing set of violations for the source code.

8. A method, comprising:
converting source code for a register transfer level design into a directed graph;
acquiring a first violation generated by a static lint check tool analyzing source code;
identifying a violation statement subgraph associated with the first violation in the directed graph;
extracting a minimal subgraph representing the first violation from the directed graph, wherein the violation statement subgraph comprises a starting point for the minimal subgraph;
executing a machine learning model that predicts a probability that the minimal subgraph matches a minimal subgraph of a second violation for different source code for which a waiver has been generated;
determining, by a processing device, that the probability is at least equal to a threshold probability; and
generating, in response to the determining, a waiver for the first violation.

9. The method of claim 8, wherein the converting comprises using an abstract syntax tree parser to perform top-to-bottom register transfer level code de-compilation that converts the source code for the register transfer level design into the directed graph.

10. The method of claim 8, wherein the extracting comprises:
extracting from the directed graph a violation statement subgraph from the directed graph based on tags in the directed graph that mark a starting point of the violation statement subgraph, wherein the violation statement subgraph comprises the starting point and a portion of the directed graph beneath the starting point;
augmenting the violation statement subgraph with a subgraph of a block statement of which a violation statement associated with the violation is a part to produce an augmented violation statement subgraph;
augmenting the augmented violation statement subgraph with a variable subgraph of a code statement of any variables of the directed graph that are computationally dependent on variables of the augmented violation statement subgraph.

11. The method of claim 8, wherein the machine learning model comprises a graph convolutional network that has been trained using a labeled set of minimal subgraphs of violations and waivers from a plurality of historical instances of source code not including the source code.

12. The method of claim 8, wherein the machine learning model is trained as a binary classification model that takes as an input the minimal subgraph and generates as an output a classification that indicates whether the minimal subgraph indicates a waiver or a genuine violation.

13. The method of claim 1, further comprising adding, in response to a human operator verifying that the waiver is valid, the minimal subgraph to a set of minimal subgraphs that is used to determine whether a third violation generated by a static lint check tool analyzing source code should be waived, wherein each minimal subgraph in the set of minimal subgraphs represents an existing waiver that was previously generated for a previously analyzed violation that was generated by a static lint check tool analyzing source code.

14. The method of claim 13, further comprising:
converting the third violation to a new directed graph;
extracting a new minimal subgraph representing the third violation from the new directed graph;
converting the new minimal subgraph to a first vector;
calculating a plurality of graph similarities, wherein each graph similarity of the plurality of graph similarities represents a similarity of the first vector to one vector in a set of vectors, wherein each vector in the set of vectors is converted from one minimal subgraph of the set of minimal subgraphs;
determining that a graph similarity of the plurality of graph similarities is at least equal to a threshold similarity; and
generating, in response to the determining that a graph similarity of the plurality of graph similarities is at least equal to a threshold similarity, a waiver for the third violation.

15. The method of claim 13, further comprising:
converting the third violation to a new directed graph;
extracting a new minimal reduced subgraph representing the third violation from the new directed graph;
converting the new minimal reduced subgraph to a first vector;
calculating a plurality of graph similarities, wherein each graph similarity of the plurality of graph similarities represents a similarity of the first vector to one vector in a set of vectors, wherein each vector in the set of vectors is converted from one minimal reduced subgraph of the set of minimal reduced subgraphs;
determining that no graph similarity of the plurality of graph similarities is at least equal to a threshold similarity; and
adding, in response to the determining that no graph similarity of the plurality of graph similarities is at least equal to a threshold similarity, the third violation to an existing set of violations for the source code.

16. A non-transitory computer readable medium comprising stored instructions which, when executed by a processor, cause the processor to:
convert source code for a register transfer level design into a directed graph;
acquire a first violation generated by a static lint check tool analyzing the source code;
identify a violation statement subgraph associated with the first violation in the directed graph;
extract a minimal subgraph representing the first violation from the directed graph, wherein the violation statement subgraph comprises a starting point for the minimal subgraph;
convert the minimal subgraph to a first vector;
calculate a graph similarity between the first vector and a second vector representing a second violation for the source code for which an existing waiver has been generated;
determine that the graph similarity is less than a threshold similarity;
execute, in response to the graph similarity being less than the threshold similarity, a machine learning model that predicts a probability that the minimal subgraph matches a minimal subgraph of a second violation for different source code for which a waiver has been generated;
determine that the probability is at least equal to a threshold probability; and
generate, in response to the determining, a waiver for the first violation.

17. The non-transitory computer readable medium of claim 16, wherein converting the minimal subgraph to the first vector comprises using an abstract syntax tree parser to perform top-to-bottom register transfer level code de-compilation that converts each register transfer level module of the first violation into the directed graph.

18. The non-transitory computer readable medium of claim 16, wherein extracting minimal subgraph representing the first violation from the directed graph further causes the processor to:
extract from the directed graph a violation statement subgraph from the directed graph based on tags in the directed graph that mark a starting point of the violation statement subgraph;
augment the violation statement subgraph with a subgraph of a block statement of which a violation statement associated with the violation is a part to produce an augmented violation statement subgraph;
augment the augmented violation statement subgraph with a variable subgraph of a code statement of any variables of the directed graph that are computationally dependent on variables of the augmented violation statement subgraph.

19. The non-transitory computer readable medium of claim 16, wherein the graph similarity is a cosine similarity.

20. The non-transitory computer readable medium of claim 16, wherein the machine learning model comprises a graph convolutional network that has been trained using a labeled set of minimal subgraphs of violations and waivers from a plurality of historical instances of source code not including the source code.
